(19) United States
(12) Patent Application Publication
(10) Pub. No.: US 2017/0351652 A1
(43) Pub. Date: Dec. 7, 2017

(54) INTELLIGENT STICKER: INFORMATION AGGREGATION, SELECTION & ANALYTICS TOOL

(71) Applicant: Chetan Krishan Singh, Gurgaon, Haryana (IN)

(72) Inventor: Chetan Krishan Singh, Gurgaon, Haryana (IN)

(21) Appl. No.: 15/535,419

(22) PCT Filed: Feb. 13, 2015
(86) PCT No.: PCT/IN2015/000082

§ 371 Date: Jun. 13, 2017

(30) Foreign Application Priority Data
Dec. 16, 2014 (IN) 3711/DEL/2014

(51) Int. Cl. G06F 17/24; G06F 21/62

(52) U.S. Cl. CPC G06F 17/241; G06F 21/6245

(57) ABSTRACT

The invention is to solve perpetual problem of loss of time and effort in collating disparate information from various sources while executing any project, compiling the collated information in usable format, making various reports and presentations and iterating till the project is complete. The invention is to also market Product and Service by generating Hot Leads or to gain Recognition effectively. The invention helps in creating Intelligent Stickers embedded with rich information related to Product, Service, Design and Knowledge topic and publishing in Personal Library (for personal use) or Public Library (to generate Hot Leads or Recognition when others use the Intelligent Sticker) of the tool. When any project is to be executed, the project related documents/drawings can be uploaded in the tool and thereafter related Intelligent Stickers specific to document/drawing can be pinned on the document/drawing. When any Intelligent Sticker is pinned, it gets pinned with its complete Attributes and when unpinned, it is removed with its complete Attributes. Thereafter numerous Analytics can be generated by combining the Attributes of different Intelligent Stickers and Attributes of the document/drawing. This process save time of the user(s) to collate the disparate information and in iteration hence executing the project fast. The tool also generates Hot Leads and Recognition for those who have published the Intelligent Stickers and published them in Public Library for use of others hence helps in marketing.

### FIELD OF THE INVENTION

The present invention is related to a method and system to aggregate disparate information related to a product, service, design or knowledge, and use them to save time to execute projects, market product and service or gain recognition.

### BACKGROUND OF THE INVENTION

The inventor is from the architecture and design industry. In his day to day activities related to designing and executing a project, he observed the problems faced by the architects, interior designers, various consultants and the architecture and interior design industry product manufacturers.

The information on products, designs and technical knowledge related to the industry remains highly scattered. While the architects, interior designers and consultants have their libraries, the information within the library is not sufficient, complete and easily available while they execute the project. In the process, they are all the time, collating information based on their design visualization from the internet, aggregators of product information on various websites, print media, email and phone calls. It takes a lot of time and effort to collect the information which still remains in the proprietary formats of individual supplier of information. The information collected further needs aggregation. Currently the same are aggregated by using MS Excel, Word and PowerPoint. The information so aggregated still remains static.

The architecture and interior design industry product manufacturers provide their product information on their website, through aggregators on the internet, printing or providing digital versions of product brochures and manuals but still much more information such as price etc. on their product needs to be collected by contact. They are also not connected to the architects, interior designers and consultants in the manner that providing information becomes quick and easy without wasting each other's time.

While designing a project drawing-wise, the designer always has a challenge in visualizing the drawing in relation to various options of designs, products or even the associated knowledge required on the specific drawing.

Also, when any one takes a buying decision on any product or service, he needs to go through the process of information collection and comparisons manually wasting his valuable time.

Looking at these problems, the inventor conceived the idea of this invention which not only solved this perpetual problem of design industry, but in a similar manner addresses all types of industries and business domains. To take other examples, in advertising industry, different designs created by the designers remain scattered and the information related to the design also remain incomplete. In fashion design industry, different components of a dress are not saved separately with their attributes so that they can be easily re-used to create a new design. In automotive industry, designing a car remains a complex process, and to collate past experience still remains a challenge. Similarly, the components manufacturers of different parts remain scattered and similar problems as faced by architects, are faced by new car designers.

### SUMMARY OF THE INVENTION

The invention is based on aggregating disparate information to create intelligent stickers related to a product, service, design and knowledge, and to use them to pin/paste/tag as per requirement to visualize the intelligent stickers in relation to the document/drawing or in relation to each other to conceive and complete a project or to buy a product or service.

Once an intelligent sticker when published for public use, is pinned/pasted/tagged by anyone, either on a document, drawing or plain canvas, it will generate hot lead or recognition for the owner of the sticker.

The stickers are intelligent as they are embedded with complete information related to the product, service, design or knowledge. The embedded information in different stickers, pinned/pasted/tagged on a document, drawing or plain canvas, together gives value added analytics to the subscriber/user.

The subscriber/user can also collaborate with his team which can be geographically distributed or with the owner of the sticker while working on the drawing, document or plain canvas, and can create many versions of his work on same drawing or document.

This invention saves time of subscriber/users to find and aggregate disparate information manually by accessing libraries, surfing the internet, print media, seeking information through email/phone contacts or personal meetings and putting together in usable format. The invention also helps subscriber/users to process the aggregated information to generate useful analytics which is otherwise manually not possible. The invention also helps subscriber/users to quickly iterate to finalize their findings to reach a conclusive and satisfying end. The invention also helps subscriber/users to collaborate and communicate at document/drawing/blank canvas level with various stakeholders including owners of the stickers. The invention also helps subscriber/users to gain recognition or to generate hot leads to effectively market their products and services.

The invention is useful for all, whether a student or a professional or a corporate from any walk of life.

### BRIEF DESCRIPTION OF DRAWINGS

Embodiments of the present invention will now be described, by way of example only, with reference to the accompanying drawings, in which:

FIG. 1 Illustrates the current Problem and its Solution through the invention according to an embodiment of the present invention;

FIG. 2 Illustrates Software solution Architecture as a Cloud Application to an embodiment of the present invention;

FIG. 3 Illustrates Software solution Architecture as a mobile embedded application/mobile application with API according to an embodiment of the present invention;

FIG. 4 Illustrates Software solution Architecture as a Desktop standalone/Desktop over Local Area Network according to an embodiment of the present invention;

FIG. 5 Illustrates the module structure, according to an embodiment of the present invention;

FIG. 6 Illustrates process flowchart of Registration of new subscribers, according to an embodiment of the present invention.

FIG. 7 Illustrates process flowchart of Subscription Module, according to an embodiment of the present invention.

FIG. 8 Illustrates process flowchart of Profile Module, according to an embodiment of the present invention.

FIG. 9 Illustrates the process flowchart of User Module, according to an embodiment of the present invention.

FIG. 10 Illustrates the process flowchart of Create Intelligent Sticker Module, according to an embodiment of the present invention.

FIG. 11 Illustrates the process flowchart of Pin Intelligent Sticker Module, according to an embodiment of the present invention.

FIG. 12 Illustrates the process flowchart of Analytics Module, according to an embodiment of the present invention.

FIG. 13 Illustrates the process flowchart of Hot Lead Module, according to an embodiment of the present invention.

FIG. 14 Illustrates the process flowchart of Recognition Module, according to an embodiment of the present invention.

### DETAILED DESCRIPTION OF DRAWINGS

Described below are the various embodiments of Intelligent Sticker: Information Aggregation, Selection and Analytics tool and its functionalities.

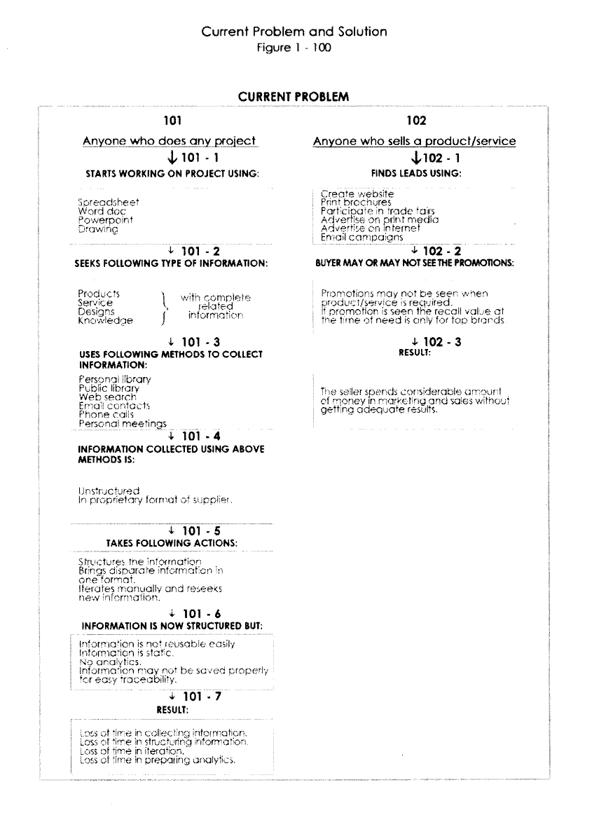

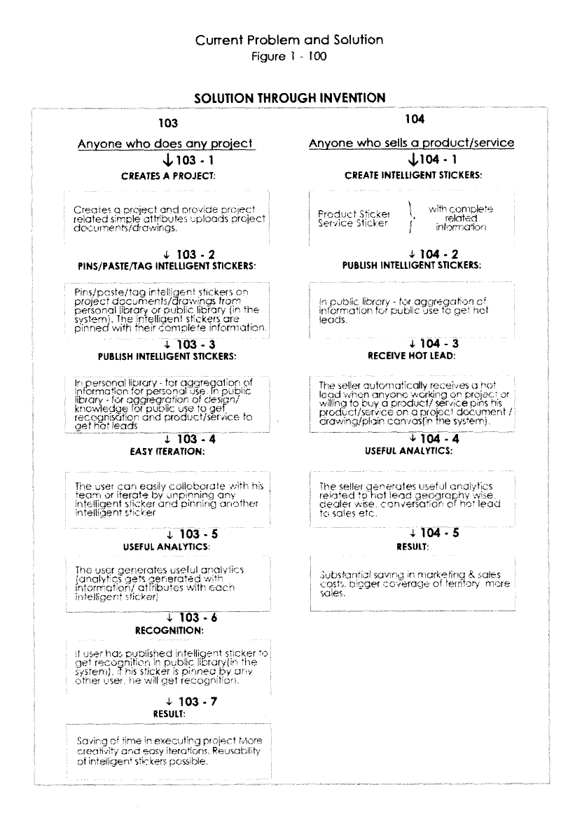

### FIG. 1 Current Problems and Solution Through Invention (100):

### Problem:

FIG. 1 illustrates the current problems face by anyone who executes any project (101). When anyone does any project, generally uses Spread Sheet, Word Document, Power Point or a Drawing to create and write/execute his project (101-1). The project executor always needs either a product information (for buying purpose for the project) and/or a service information (for buying purpose for the project) and/or a design information (for designing the project) and/or knowledge along with complete related information to proceed in project life cycle (101-2). All the information required in (101-2) may be searched from personal library and/or public library and/or web search and/or seeking information through e mails and/or phone calls and/or personal meetings (101-3). When he collects information using various sources as per (101-3), the information is unstructured and in the proprietary formats of the supplier of information. Further in a single search all information in not generally available hence multiple contacts with suppliers are required. This wastes his time and the project also takes longer to complete (101-4). After receiving the information, the project executor structures the information in desired format and also iterates multiple times either alone or in collaboration with supplier of information/his team/client. Wherever required in iteration process, he again collects the information as per (101-3). This process continues for as many times as required (101-5). Once the process of information collection, structuring and iteration is complete, the information thus collected still remains static. If he wants to further analyze the information, he needs to prepare the analytics manually. Further on completion of the project the information is saved as a project and may not be re-useable easily for other projects or many times may be lost as not saved in structured manner for easy traceability (101-6). The execution and completion of a typical project takes longer due to effort required for collection of information, structuring information in required format, repetition of same process for iteration and manually preparing the analytics (101-7).

Anyone who sells his product/service promotes the same by various methods such as creating websites, printing brochures, participating in trade fairs, advertising on print media, advertising on internet and campaigns through e mails etc. (102-1). It is not necessary that the project executor who needs any product/service for his project may see the promotions of the supplier or remember it while he is executing the project. Even if he is aware of some suppliers, he still needs to contact them for more information as information in promotion is not adequate for project execution (102-2). This results in supplier of product and service to spend considerable amount of money for promotion without getting adequate results (102-3).

### Solution Through Invention:

The project executor creates a project in Intelligent Sticker: Information Aggregation, Selection and Analytics Tool with simple project attributes and also uploads his project document(s) or project drawing(s) (103-1). The tool has personal and public library of Intelligent Stickers (packets with rich information related to a product, a service, a design or a knowledge topic). The personal library is created by user whereas the public library is created by all such users including the user who wish to either get recognition or hot lead. The user pins the relevant Intelligent Sticker on specific project document/drawing and also sees complete information related to Intelligent Sticker. The Intelligent Stickers are pinned along with their complete attributes/information on the document (103-2). While he is executing the project, he can at any time create an Intelligent Sticker (product, service, design and knowledge) for private or public use which can be used in the same project and can also be re used in other projects (103-3). He can collaborate with Intelligent Sticker owner, his team and his client and can also iterate easily by simply unpinning any Intelligent Sticker(s) and pinning another Intelligent Sticker(s) (103-4). The project executor(s) can also get useful analytics which is generated by processing the attributes of project, specific document/drawing with the attributes of Intelligent Stickers pinned (103-5). While many different unconnected users work on the tool, if any user pins any Intelligent Sticker published by another user in public library for the purpose of recognition, the owner of the Intelligent Sticker gets recognition (103-6). This invention saves time, enhances creativity, visualization, enables easy iteration, collaboration and re usability of the Intelligent Sticker (103-7).

Anyone who sells a product/service creates Intelligent Stickers with complete information/attributes in Intelligent Sticker: Information Aggregation, Selection and Analytics Tool (104-1). He publishes the same in public library of the tool to get hot leads when anyone pins the Intelligent Sticker. Before he publishes the Intelligent Sticker he also defines who all can view his Sticker Geography wise, type of user wise etc. (104-2). When anyone pins his Intelligent Sticker while executing his project, the seller of product/service automatically gets hot lead. The seller can also generate useful analytics (104-3). This results in substantial saving in marketing and sales costs, increased sales territory resulting in more sales (104-4).

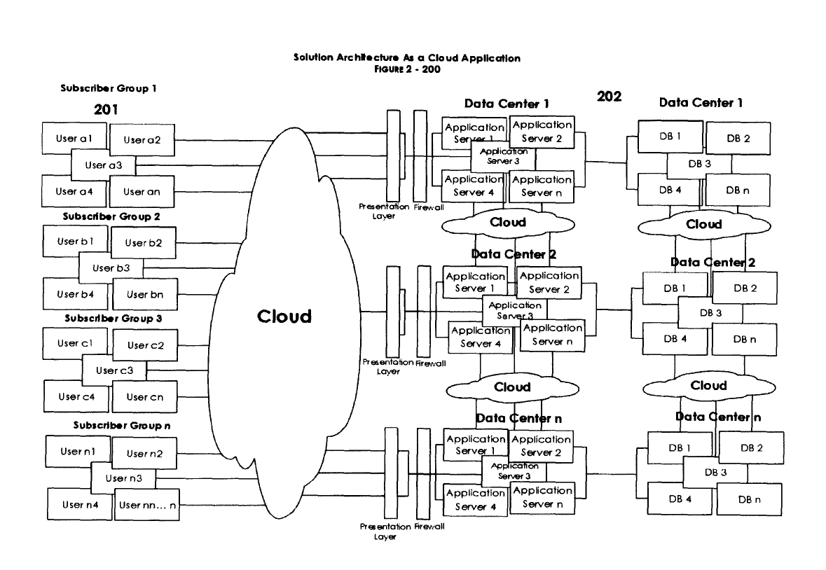

### FIG. 2 Solution Architecture as a Cloud Application (200):

In an embodiment of the present invention the FIG. 2 illustrates the Architecture as a Cloud Application. There can be n number of different subscriber groups with as many users as required in any subscriber group who can access the tool on Cloud from their computers (201). The tool can be hosted on n number of data centers worldwide with n number of presentation layers, firewalls, application servers and database servers. The entire network of servers are connected through Cloud (202).

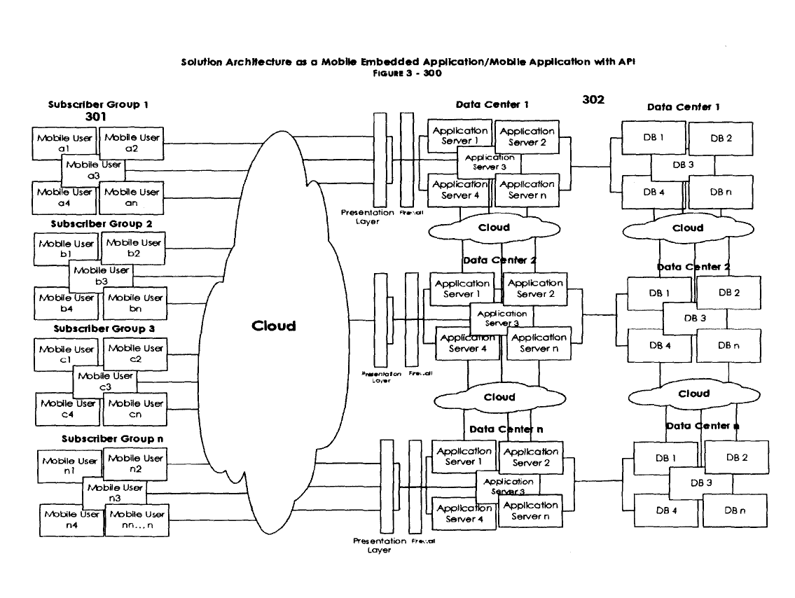

### FIG. 3 Solution Architecture as a Mobile Embedded Application/Mobile Application (300):

In another embodiment of the present invention the FIG. 3 illustrates the Architecture as a Mobile Embedded Application/Mobile Application. There can be n number of different subscriber groups with as many users as required in any subscriber group who can access the tool on Cloud from their hand held devices (301). The tool can be hosted on n number of data centers worldwide with n number of presentation layers, firewalls, application servers and database servers. The entire network of servers are connected through Cloud (302).

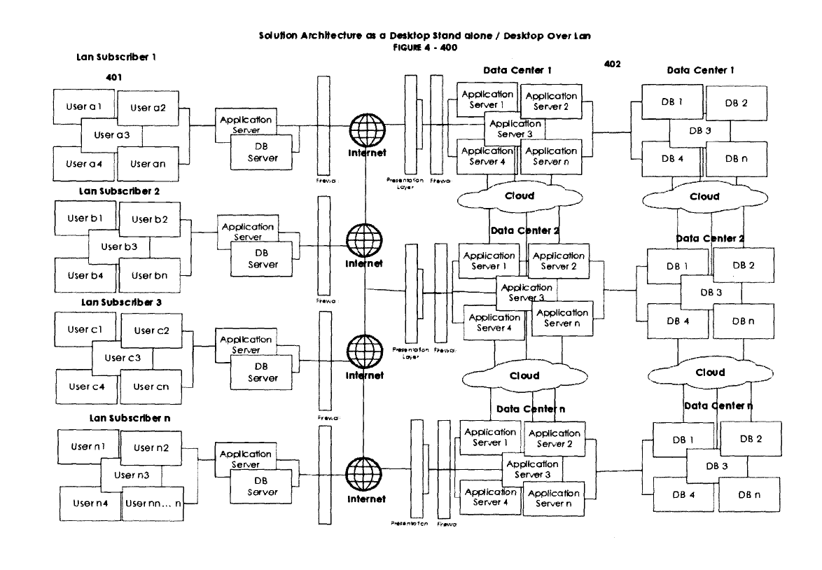

FIG. 4 Solution Architecture as a Desktop Standalone/Desktop over LAN (400):

In another embodiment of the present invention the FIG. 4 illustrates the Architecture as a Desktop Standalone/Desktop over LAN Network Application. There can be n number of different subscriber groups with n number of users with n numbers of standalone desktop computers or LAN network or with n number of application servers, database servers and firewalls. The network will be connected through n number of internet connections (401). They can take periodical updates from the application hosted on n number of datacenters with n number of firewalls, application servers and database servers. (402).

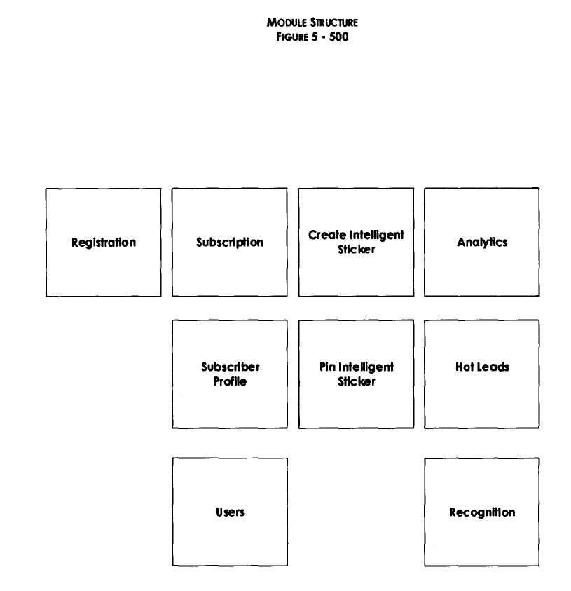

### FIG. 5 Module Structure (500):

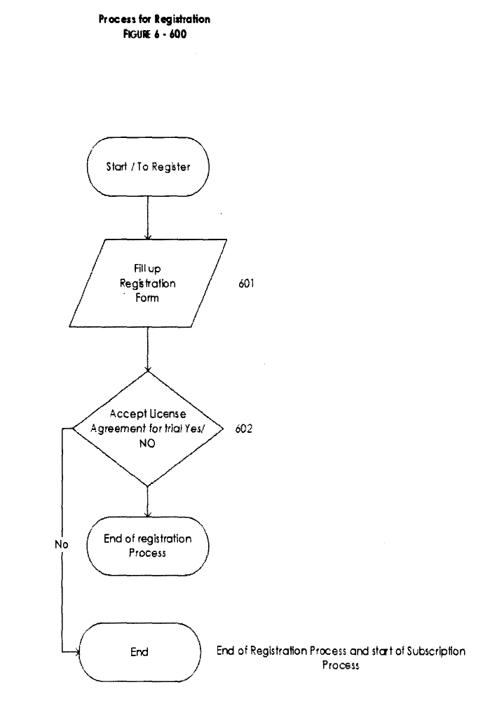

FIG. 5 illustrates the Module Structure of the tool. For ease of understanding only the modules which impact the Invention are illustrated. The modules are Registration, Subscription, Subscriber Profile, Users, Create Intelligent Sticker, Pin Intelligent Sticker, Analytics, Hot Leads and Recognition. In realty there can be more modules. In other embodiments the module names can also be different however the functionality may remain the same. Each module is with its work flow is explained in FIGS. 6 to 14.

### FIG. 6 Process for Registration (600):

FIG. 6 illustrates the process for registration of a new user. Anyone desiring to use the tool can register by visiting the website of the tool and fill up Registration Form (601). There after he takes decision to accept or decline the License Agreement (602). If he accepts the license, he gets the access of the tool for trail purpose if he decline, he does not register.

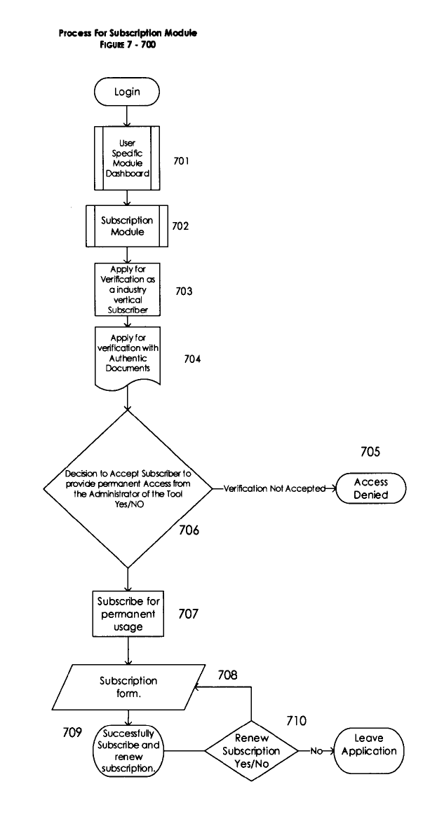

### FIG. 7 Process for Subscription Module (700):

FIG. 7 illustrates the process for Subscription Module. The subscriber logs in and reaches subscriber specific module dash board (701). By clicking Subscription Module the subscriber reaches the Subscription Module (702). The subscriber apply to the administrator of the tool for verification by uploading relevant documents (704) as an industry vertical subscriber for example as an Architect for Construction Industry, as a Fashion Designer for Design Industry etc. (703). The administrator of the tool decides by verifying the uploaded documents to accept or decline the subscriber to continue in the tool (706). If accepted, the subscriber subscribe for permanent usages (707). If verification not accepted the access to the tool is denied (705). The subscriber fills up subscription form (708) and successfully subscribes (709). He takes a decision to renew subscription (710) if decides in favour, repeats process (708) if decides against renewal, leaves the tool.

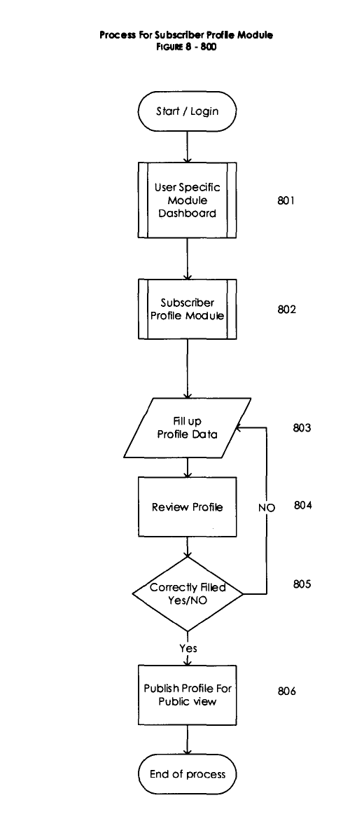

### FIG. 8 Process for Profile Module (800):

FIG. 8 illustrates the process to create the user profile. The Subscriber logs in the tool and reaches subscriber specific module dash board (801). The Subscriber clicks on Profile Module and reaches Profile Module (802). The Subscriber fill up profile data (803) and reviews profile (804). The Subscriber decides if the profile is correctly filled in (805). If correctly filled in then publishes the profile for public view (other users in the tool) (806). If profile is not correctly filled in, redo the process (803), (804) and (805). The publishing of profile is important for the Invention as when any user pins any Intelligent Sticker, can also view the profile of the owner of the Intelligent Sticker.

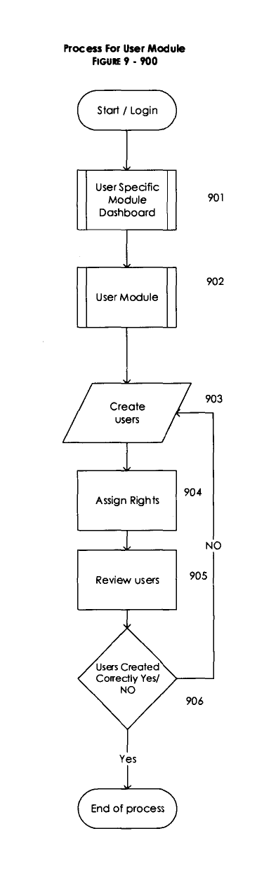

### FIG. 9 Process for User Module (900):

FIG. 9 illustrates the process to create users. The Subscriber logs in the tool and reaches subscriber specific module dash board (901). By clicking the User Module the Subscriber reaches User Module (902). He creates the users (903), assigns rights to users (904), reviews the users created and rights assigned (905). The User decides if the users are correctly created (906). If the users are correctly created, it the end of the process and if users are not correctly created, the subscriber repeats the process (903), (904), (905) and (906).

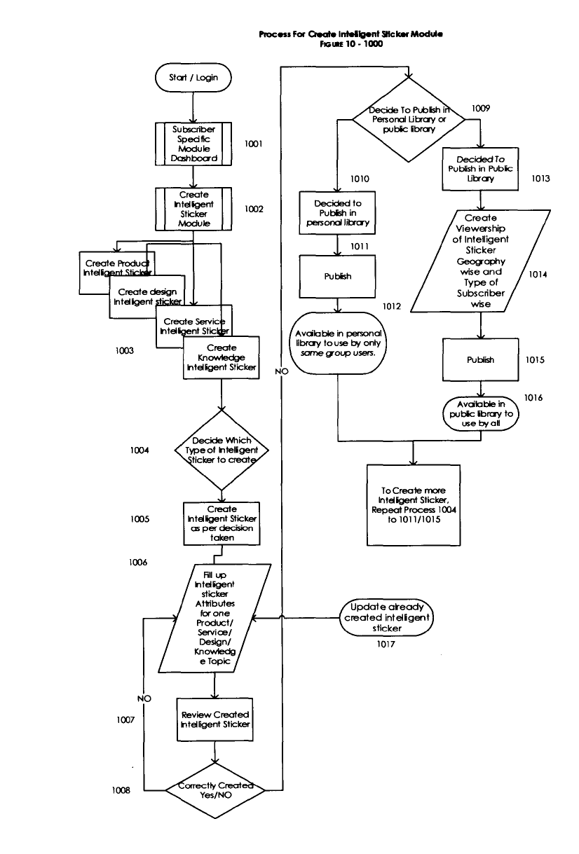

### FIG. 10 Process for Create Intelligent Sticker Module (1000):

FIG. 10 illustrates the process for creating Intelligent Sticker. The Subscriber/user logs in the tool and reaches Subscriber Specific Module Dash Board (1001). By clicking the Create Intelligent Sticker Module the subscriber/user reaches Create Intelligent Sticker Module (1002). The subscriber/user gets the option to create Product Intelligent Sticker, Design Intelligent Sticker, Service Intelligent Sticker and Knowledge Intelligent Sticker (1003). The subscriber/user decides which type of Intelligent Sticker to be created (1004). Creates any one type of the Intelligent Stickers (1005). Fills up Intelligent Sticker attributes for one product/service/design/knowledge topic (1006). He reviews created Intelligent, Sticker (1007). Takes decision if correctly created (1008). If not created properly, repeats process (1006), (1007), (1008). If correctly created takes a decision to publish the Intelligent Sticker in personal library or public library of the tool (1009).

Decides to publish in personal library (1010) and publishes the same in personal library (1011). Now the Intelligent Sticker is available for pinning by only users of the same subscriber (1012). He repeats the process (1004), (1005), (1006), (1007), (1008), (1009), (1010) (1011) to create as many Intelligent Stickers as required for publishing in personal library. The subscriber/user decides to publish the Intelligent Sticker in public library (1013). Enters relevant information on viewership of the Intelligent Sticker geography wise and type of subscriber wise (1014). Publishes the Intelligent Sticker in public library (1015). The Intelligent Sticker published in public library is now available for pinning to the type of the subscribers and geographies opted for viewership (1016). He repeats the process (1004), (1005), (1006), (1007), (1008), (1009), (1013) (1014) to create as many Intelligent Stickers as required for publishing in public library.

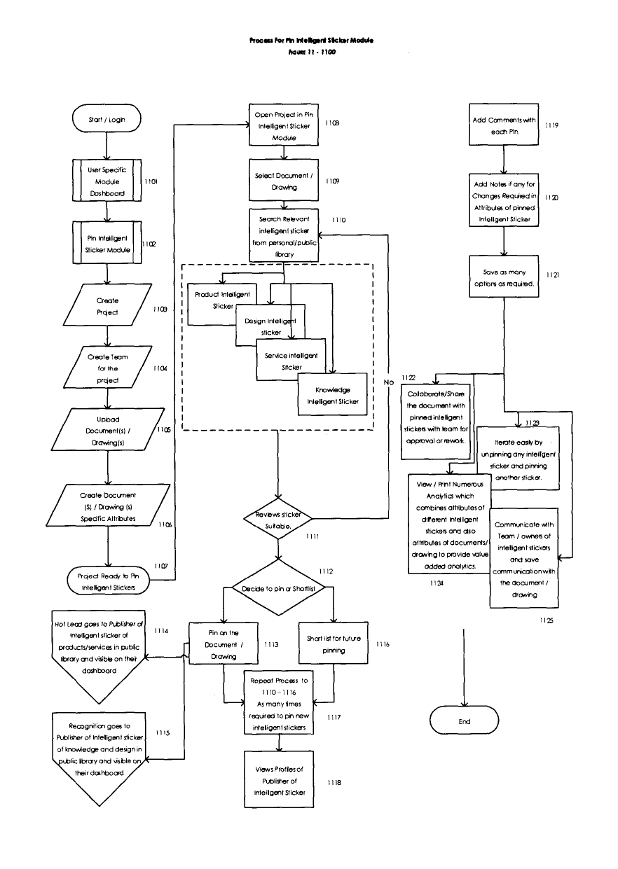

### FIG. 11 Process for Pinning Intelligent Sticker (1100):

FIG. 11 illustrates the Process for Pinning/Tagging/Using/Pasting Intelligent Sticker. The Subscriber/user logs in the tool and reaches Subscriber Specific Module Dash Board (1101). By clicking the Pin Intelligent Sticker Module the subscriber/user reaches Pin Intelligent Sticker Module (1102). The subscriber/user creates a project on which he wants to work (1103). He creates team for the project by selecting specific users (from the group of users created by him in User Module) (1104). He uploads n number of documents/drawings in the project (1105). He creates document/drawing related specific attributes for all n number of documents/drawings (1106). The project is now ready to pin the Intelligent Stickers (1107).

The subscriber/user open project in which he wants to work (there can be n number of projects) Pin Intelligent Sticker Module (1108). He selects specific drawing/document from n number of drawings/documents uploaded with the project to start pinning Intelligent Stickers (1109). He searches relevant Intelligent Sticker from his personal library or public library in the tool. These Intelligent Stickers can be related to Product, Design, Service or Knowledge (1110). He reviews if the Intelligent Sticker is suitable (1111). If the Intelligent Sticker is not suitable, repeats process (1110). If the Intelligent Sticker is suitable he decides if he wants to pin the same to the document/drawing (selected) or shortlist for future pinning (1112). If he decides to pin then he pins the Intelligent Sticker to the document/drawing (1113). As soon as he pins any Intelligent Sticker chosen from public library a hot lead goes to the publisher of the Intelligent Sticker for Product/Service and is visible to the publisher in his Hot Lead Module (1114). If he has pinned any Intelligent Sticker chosen from public library related to Design/Knowledge, a Recognition goes to the Publisher of the relevant Intelligent Sticker and is visible to the Publisher in his Recognition Module (1115). The subscriber/user can shortlist any Intelligent Sticker for future pinning (1116). He repeats the process (1110) to process (1116) as many times as required to shortlist/pin new Intelligent Stickers on same drawing/document or new drawing/document. Each time an Intelligent Sticker is pinned, it is pinned with its complete attributes (1117). He can easily view profiles of the publisher of Intelligent Stickers (1118). He can add comments with each pinned Intelligent Sticker (1119). He can add notes for any changes required in attributes of pinned Intelligent Stickers (1120). He can save as many options as required to create different versions on same document/drawing and pin new Intelligent Stickers for each option (1121). He can collaborate or share any or all options of documents with pinned Intelligent Stickers with team for approval or rework (1122). He/project team can iterate easily by unpinning any Intelligent Sticker and pinning another Intelligent Sticker (1123). He/project team can view/print numerous analytics which is generated by combining attributes of different Intelligent Stickers or/and attributes of the drawing/document (1124). He/project team can communicate with the publishers of the Intelligent Stickers in public library or with each other and save communication with the related document/drawing on which the Intelligent Sticker has been pinned (1125).

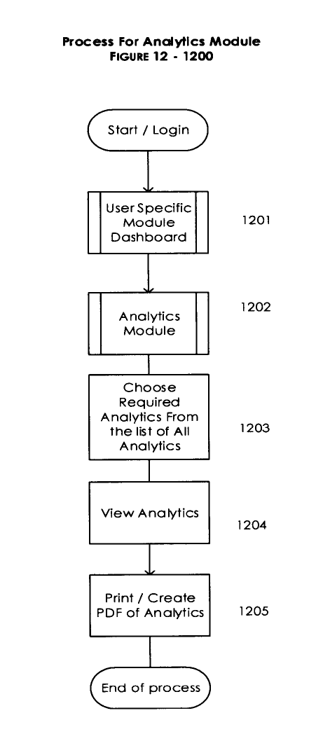

### FIG. 12 Process for Analytics Module (1200):

FIG. 12 illustrates the Process for Analytics Module. The Subscriber/user logs in the tool and reaches Subscriber Specific Module Dash Board (1201). By clicking the Analytics Module the subscriber/user reaches Analytics Module (1202). The subscriber/user chooses the required Analytics from the list of all available Analytics (1203). He views the Analytics (1204). He prints/creates PDF of the Analytics for e mailing (1205).

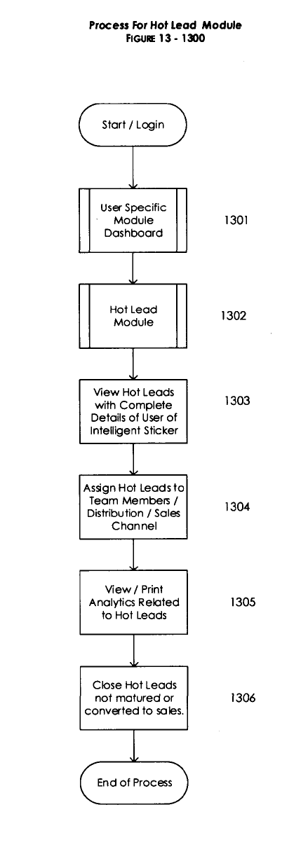

### FIG. 13 Process for Hot Lead Module (1300):

FIG. 13 illustrates the Process for Hot Lead Module. The Subscriber/user logs in the tool and reaches Subscriber Specific Module Dash Board (1301). By clicking the Hot Lead Module the subscriber/user reaches Hot Lead Module (1302). He views the hot leads received from the users of his Intelligent Stickers published in public library with complete details about the subscriber and the project (1303). He assigns the hot leads to any other user within his subscription or to his distribution/sales channel (1304). He views/prints Analytics related to Hot Leads (1305). He can close Hot Leads not matured or converted to sales (1306).

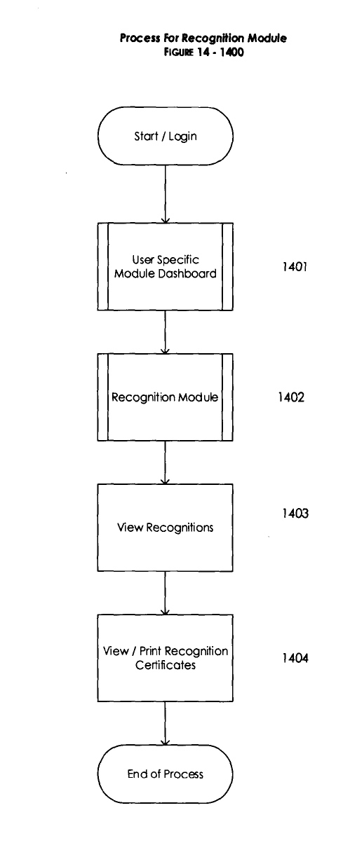

### FIG. 14 Process for Recognition Module (1400):

FIG. 14 illustrates the Process for Recognition Module. The Subscriber/user logs in the tool and reaches Subscriber Specific Module Dash Board (1401). By clicking the Recognition Module the subscriber/user reaches Recognition Module (1402). He views the Recognition received from the users of his Intelligent Sticker published in public library (1403). He views/prints Recognition Certificate.

I claim:

1. A method for creating Intelligent Sticker and pinning or unpinning them with their Attributes on documents/drawings/plain canvas comprising of the following steps:
a. Creating and updating Product Intelligent Sticker or creating Service Intelligent Sticker or creating Design Intelligent Sticker or creating a Knowledge Intelligent Sticker with related Attributes,
b. Publishing Intelligent Sticker in Personal Library for own use or in Public Library of the tool for the use of others,
c. Controlling viewership and usage of the Intelligent Sticker in Public Library Geography wise and type of viewer wise or restricting the view and usage till allowed by the Publisher of the Intelligent Sticker in Public Library on request of the user who wants to view the Intelligent Sticker,
d. A method to create a project, upload document/drawing and specify their Attributes
e. Searching and Short listing, pinning, unpinning Intelligent Stickers on drawings/documents and writing notes with each Intelligent Sticker
f. A method to carry the Attributes of each Intelligent Sticker along with it whenever it is pinned or unpinned
g. Save as many options, collaborate with the team or client, communicate with the team/client or Publisher of Intelligent Sticker(s), view Profile of the Publisher of the Intelligent Sticker, and view all Attributes of the Intelligent Sticker,
h. View/print/e mail various Analytics generated by combining Attributes of different Intelligent Stickers pinned and Attributes of different documents/drawings.

2. A method to generate Hot Leads or Recognition comprising of following steps:
a. When an Intelligent Sticker related to Product or Service from Public Library is pinned with any document/drawing/plain canvas, a Hot Lead automatically goes to the Publisher of Intelligent Sticker of the Product or Service with complete details about the project and the subscriber/user,
b. When an Intelligent Sticker related to Design or Knowledge from Public Library is pinned with any document/drawing/plain canvas, a Recognition automatically goes to the Publisher of the Intelligent Sticker of Design or Knowledge

3. A method of claim 1, to create Solution Architecture of Intelligent Sticker:
Information Aggregation, Selection and Analytics tool comprising of:
a. Cloud based Solution Architecture with all technologies
b. Mobile embedded application/mobile application with API Solution Architecture with all technologies,
c. Desktop standalone/desktop over LAN Solution Architecture with all technologies.

4. A method of claim 1 to access Intelligent Sticker: Information Aggregation, Selection and Analytics tool comprising of:
a. Receiving a request from any user to access the tool based upon the access rights and access protocol,
b. Providing complete security to each subscriber and related user for his Personal Data and Personal Library.

5. A method of claim 1 to create Profile of each Subscriber to enable the users of Intelligent Stickers to view the Profile of the Publisher while pinning the Intelligent Sticker.

6. A method of claim 1 to create Users by the Subscriber so that the users can work on Projects and pin Intelligent Stickers.
